(19) United States
(12) Patent Application Publication
(10) Pub. No.: US 2009/0164552 A1
(43) Pub. Date: Jun. 25, 2009

(54) Novel system and method to push content from a website to a remote device

(76) Inventor: Jeremy Chi Ching Wei, Taipei (TW)

Correspondence Address: AGNEW INTERNATIONAL;PATENT & TRADEMARK LAW FIRM, 1300 BRISTOL STREET NORTH, SUITE 100, NEWPORT BEACH, CA, 92660, US

(21) Appl. No.: 12/020,724

(22) Filed: Jan. 28, 2008

Related U.S. Application Data
(60) Provisional application No. 61/015,496, filed on Dec. 20, 2007.

(51) Int. Cl. G06F 15/16

(52) U.S. Cl. 709/202

(57) ABSTRACT

In the present invention, a system and method for pushing information from a host system to a remote device where the agent of pushing system recognizes any new content posted on the website and retrieve the new content to the host system and then redirected to the remote device is provided.

### CROSS REFERENCE TO RELATED APPLICATION

This application claims the benefit of priority under 35 U.S.C. 119(e) to the filing date of U.S. provisional patent application No. 61/015,496 entitled “Novel system and method to redirect content from a websites to a remote device” which was filed Dec. 20, 2007, and is incorporated herein by reference.

### BACKGROUND OF THE INVENTION

1. Field of the Invention

The present invention is generally directed to the field of a pushing system with the agent of the system retrieving content from a designated website and then redirecting the content to a remote device.

2. Background Information

In present days, blog is a widely accepted and popular form of communication. A typical blog is a website where entries are written in chronological order and commonly displayed in reverse chronological order. Many blogs provide commentary or news on a particular subject; others function as more personal online diaries. A typical blog combines text, images, and links to other blogs, web pages, and other media related to its topic. The ability for readers to leave comments in an interactive format is an important part of many blogs. While most blogs are primarily textual, some blogs provide platform for art, photographs, video file, music fie, and audio podcast. Likewise, video sharing website where users can upload, view and share video clips are also immensely popular. Similarly, music sharing website that allows users to upload and share music clips are also immensely popular.

A general problem for the users of blogs, video sharing, music sharing and websites of the like is the fact that the content of the websites are updated constantly. Users who are interested in particular topics have to manually monitor the websites for new contents. This is particularly troublesome if the users need to monitor a large number of websites with interests on various topics. In the context of blogs, a user may fail to respond to a posting because the user can only periodically monitor the blogs.

Thus, there is a general need in this field for a more automated, continuous, efficient, flexible, and reliable system of ensuring that user will always receive new content and from the websites of interests to the designated remote device such as cellular phones, remote desktops, remote laptops or the likes.

### SUMMARY OF THE INVENTION

In the present invention, a system and method for pushing information from a host system to a remote device where the agent of pushing system recognizes any new content posted on the website and retrieve the new content to the host system and then redirected to the remote device is provided.

Specifically, a push system is disclosed where the push system is comprised of a host system residing in a computer and preferably in server computer, an agent program of the push system that is capable of recognizing new content from a designated website based on predetermined attributes provided by the user, the agent program of the push system capable of retrieving the content from the designated website to the host system, a redirect program that redirects the content from the host system to the remote system, and a filtering system for which the redirect program filters the new content before it is pushed to the remote device.

Typically, an agent program of the push system located the host system will sense new content posted on the designated website and retrieve the new content. The agent program operates in connection with attribute applications at the host system to configure and detect a particular user-defined content, and then redirect the new content to a remote device

Using the agent program, the user can select certain new content items for retrieval, such as new text postings, new video or new music uploads.

Having selected the content for retrieval, the user then can configure one or more agent programs to detect new contents at the designated website or websites. Thereafter, the one or more agent programs will be able to retrieve the new content to the host system. Used in connection with the agent program, the redirection program initiates the redirection of the newly retrieved content from the host system to the remote device. The agent program may be scheduled to detect new content continuously or intermittently based on predetermined attributes.

The redirector program also provides a set of software-implemented control functions for determining the type of remote device and its address, for programming a preferred list of content types that are to be redirected, and for determining whether the remote device can receive and process certain types of content attachments, such as music or video attachments.

The remote device control functions are initially set by the user of the remote device at the host system. These functions can then be altered on a global or per message basis by transmitting a command message from the remote device to the host system.

In an alternative embodiment, the push system executes on a network server, and the server is programmed to send out agent program or programs to the designated website or websites and once the agent program retrieves new content the redirect program will push to content to the remote device via either a local-area-network (“LAN”) or the wide-area-network (“WAN”).

This alternative configuration could also include an Internet or Intranet-located web server where the push system can be accessible through a secure Web page or other user interface. In this configuration, the push system could be located on an Internet Service Provider (“ISP”) system or an Application Service Provider (“ASP”) system, and the user would configure or reconfigure the push program controls over an Internet connection to the ISP or ASP system.

A primary advantage of the present invention is that it provides a push system where an agent program of the push system will continuous and real-time monitor new content available at the designated website. The agent then retrieves the new content back to the host system and the redirection program redirects the new content to a remote device.

Other advantages of the present invention include: (1) flexibility in defining the types of content to monitor and to retrieve, the type of websites to which will host the new content and in defining a preferred list of content types that are to be monitored and to be retrieved; (2) flexibility in configuring the system to determine what type of content, once retrieved, should be redirected; (3) flexibility in configuring the system to determine what remote device to be forwarded to and in defining a preferred list of remote device to forward to.

The present invention also provides a method of gathering new content from a designated website and redirect the new content to a remote device comprising the steps of determining the designated website to be monitored, determine the type of new content to be detected at the designated website, monitoring new content at the designated website by an agent program, detecting new content at the designated website by the agent program, retrieving the new content from the designated website to the host system by the agent program, providing a set of filtering rules which are configurable by a user and preferably remotely configurable by a user where the filtering rule may be applied to the redirection program in determining whether the new content should be redirected to the user's remote device, determining whether the new content should be redirected from the redirection program to the user's remote device, and if the new content should be redirected, the redirect program redirects the new content the user's remote device.

Optionally, encryption program encrypts the new content to form an encrypted new content and transmit the encrypted new content to the user's remote device. Where the push system is supporting more than one user, a configurable activation/deactivation switch is also preferably provided for turning on/off the operation of the agent program for a particular user, and a configurable activation/deactivation switch is also preferably provided for turning on/off the operation of the redirect program for a particular user.

In yet another embodiment, the receiver of the agent program, to which is installed in a remote device, may be capable sending returning data item, in response to receiving new content from the redirect program, back to the host system, wherein the agent program, after detecting the returning data item being received by the host system, will redirect the returning data item to a location based on at least one predetermined attribute.

For example, the returning data item can be a text message. The user can preprogram or customize the text message and the text message will be routed by the receiver of the push system back to the host system after new content has been received by the receiver of the push system. And based on a predetermined route map or table, the agent of the host system will reroute the text message from the host system to the predetermined location. An example of a predetermined location is the website where the agent program originally retrieved the new content. Another example of the predetermined location can be an email account. In this embodiment, the agent program may utilize a SMPT server to send the text message to the email account.

These are just a few of the many advantages of the present invention, as described in more detail below. As will be appreciated, the invention is capable of other and different embodiments, and its several details are capable of modifications in various respects, all without departing from the spirit of the invention. Accordingly, the drawings and description of the preferred embodiments set forth below are to be regarded as illustrative in nature and not restrictive.

### BRIEF DESCRIPTION OF THE DRAWINGS

The present invention satisfies the needs noted above as will become apparent from the following description when read in conjunction with the accompanying drawings wherein:

FIG. 1 is a system diagram showing the push system of the present invention where the agent program of the push system resides at the host system, where the agent program of the push system monitors and gathers new content from the designated website and retrieve said new content to the host system via the internet network and thereafter via the redirect program to redirect the new content from the host system via internet network to the remote device.

FIG. 2 is a system diagram showing an alternate embodiment of the push system of the present invention where the push system resides at the host system on a computer server.

FIG. 3 is the system diagram of FIG. 1 further includes a filtering system where the filtering system filters the new content. The filter system can have at least one filtering rule based on at least one predetermined attribute.

FIG. 4 is another alternate example of present invention where the system diagram depicts a remote control device that allows user to configure the push system via a remote device.

In FIG. 5, the system diagram of FIG. 3 is depicted with encryption program encrypting the content before it is redirected to the remote device.

In FIG. 6, the system diagram depicts the receiver capable of sending returning data item, in response to receiving new content from the redirect program back to the host system and the agent program will redirect the returning data item to a location based on at least one predetermined attribute.

FIG. 7 is a flow chart showing the steps carried out by the agent program operating at the host system and how it interfaces with the designated website and retrieve the information from the designated website to the host system.

FIG. 8 is a flow chart showing the interaction of the redirect program with other components of the host system in FIG. 1 to enable the redirection of the new content from the host system to the remote device.

### DETAILED DESCRIPTION OF THE DRAWINGS

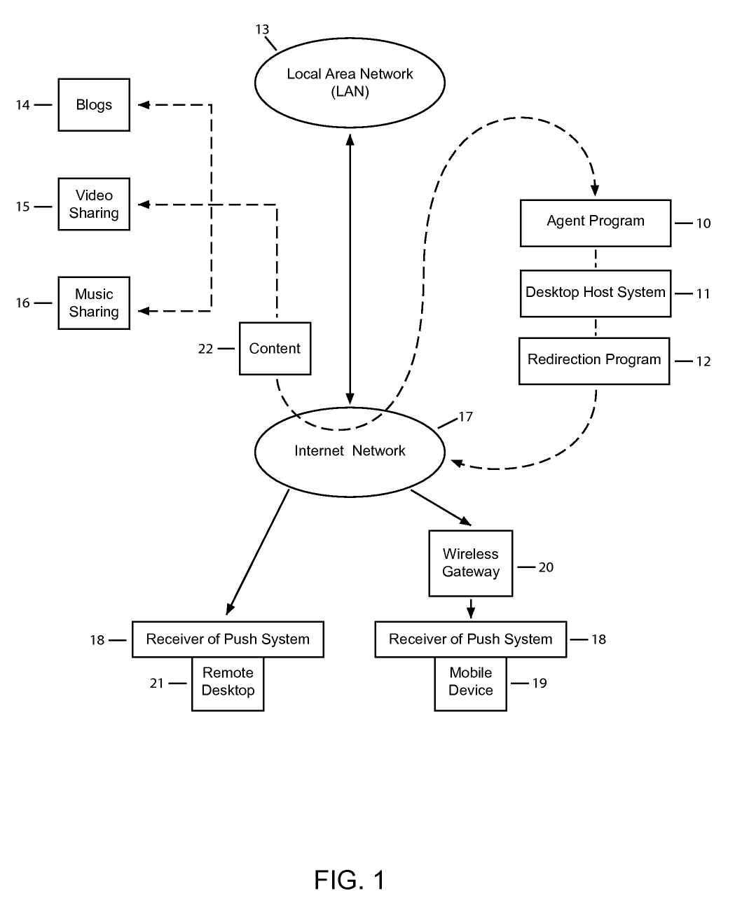

Referring now to the drawings, FIG. 1 is an example system diagram showing the agent program 10 of the push system monitoring websites such as blogs 14, video sharing websites 15 or music sharing websites 16 via internet network 17 and retrieve the content 22 back to the host system 11 via internet network 17 where the redirection program 12 redirects the content 22 through internet network 17 to remote devices such as remote desktops 21 which is installed with the receiver of the push system 18, or through the wireless gateway 20 to mobile device 19 installed with the receiver of the push system 18.

In FIG. 1, the host system 11 resides at the user's desktop system, typically located in the user's office. The desktop host system 11 is connected to a LAN 13, which also connects to other computers that may be in the user's office or elsewhere. The LAN 13, in turn, is connected to a wide area network (WAN) such as the internet network 17 which is defined by the use of the Transmission Control Protocol/Internet Protocol (“TCP/IP”) to exchange information, but which, alternatively, could be any other type of WAN.

The connection of the LAN 13 to the Internet network 17 is via high bandwidth link, typically a T1 or T3 connection. The internet network 17 in turn is connected to a variety of gateways 20. A gateway forms a connection or bridge between the internet network 17 and some other type of network, such as a radio frequency wireless network, cellular network, satellite network, or other synchronous or asynchronous land-line connection. As in the example of FIG. 1, a wireless gateway 20 is connected to the internet network 17 for communicating via wireless link to a plurality of wireless mobile devices 19.

The preferred mobile device 19 is a wirelessly enabled palm-top computer, a mobile telephone with data messaging capabilities, or a wirelessly enabled laptop computer, but could, alternatively be other types of mobile devices capable of sending and receiving messages the wireless gateways 20. The mobile device 19 includes receiver of the push system 18 that works in conjunction with the redirection program 12 to enable the seamless redirection of user-selected content.

In another preferred embodiment, the remote desktop 21 is able to configure the push system via the internet network 17. Likewise, the mobile device is able to configure the push system through the wireless gateway 20 and the internet network 17.

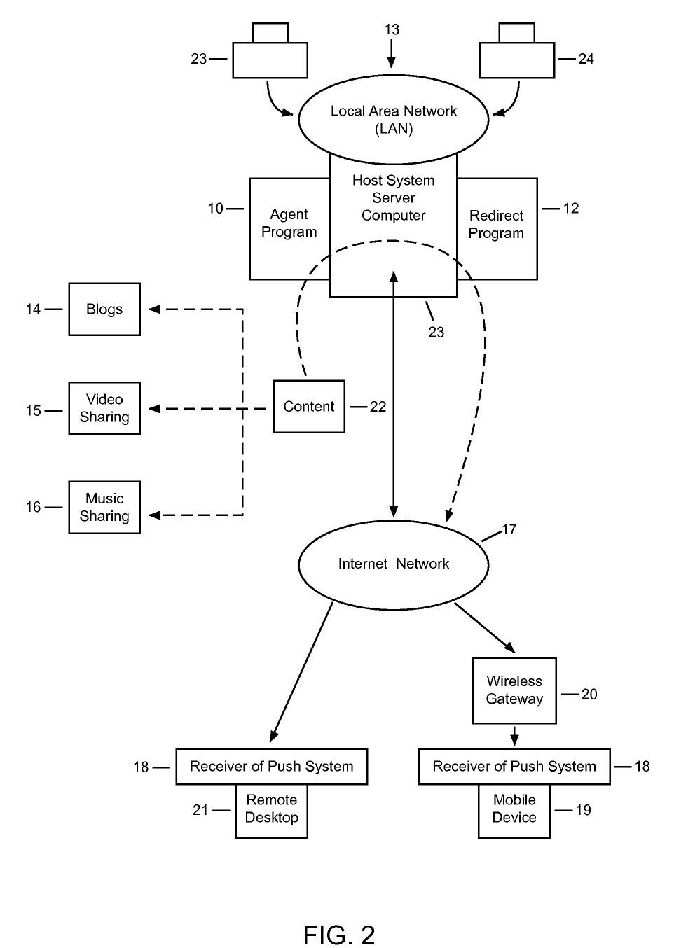

FIG. 2 is an alternate example of system diagram showing the agent program 10 of the push system monitoring websites such as blogs 14, video sharing websites 15 or music sharing websites 16 via internet network 17 and retrieve the content 22 back to the host system 11 where the host system in this case resides at a server computer 23. Once the content is retrieved back to the host system 23, the redirect program 12 redirects the content through internet network 17 to remote devices such as remote desktops 21, or through the wireless gateway 20 to mobile device 19 where both the remote desktops 21 and the mobile device 19 are installed with receiver of the push system 18. In this depiction, other desktops 23 and 24 connected to the host system 23 via LAN are able to control the host system located in the server computer and also receive the new content if desktops 23 and 24 are installed with the receiver if the push system.

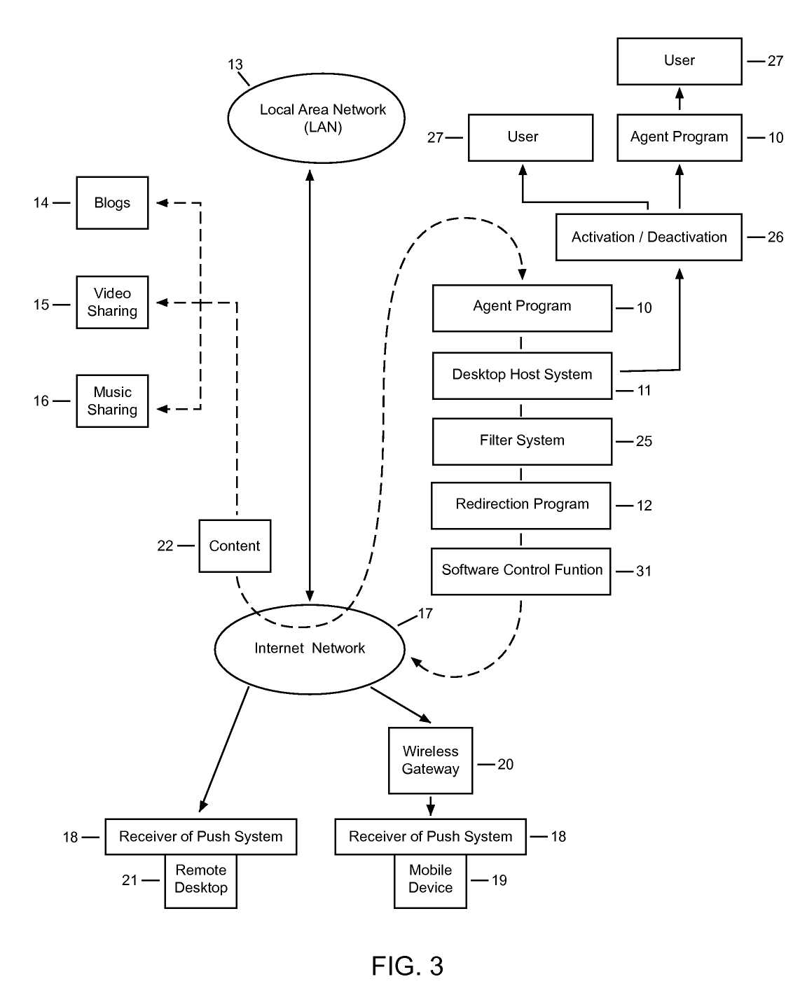

FIG. 3 is another alternate example of present invention where the system diagram of FIG. 1 further includes a filtering system 25 where the filtering system filters the new content 22 before the redirection program 12 redirects the new content 22 to the remote devices 21 or 19. The filter system 25 can have at least one filtering rule based on at least one predetermined attribute. The predetermined attribute can be provided by an user.

Further depicted is the software control function 31 which is capable of determining whether the remote device 19 or 21 can receive or process the new content 22. Also depicted here is the configurable activation/deactivation switch 26 capable of activating/deactivating the user 27 or the agent program 10 for a particular user 27.

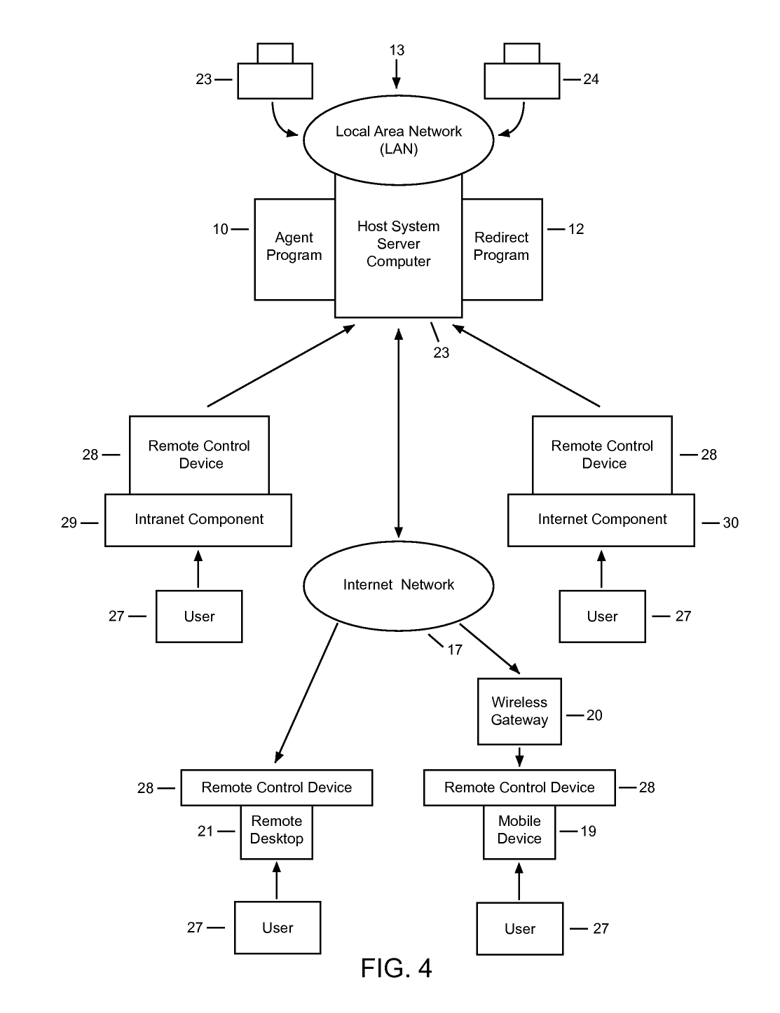

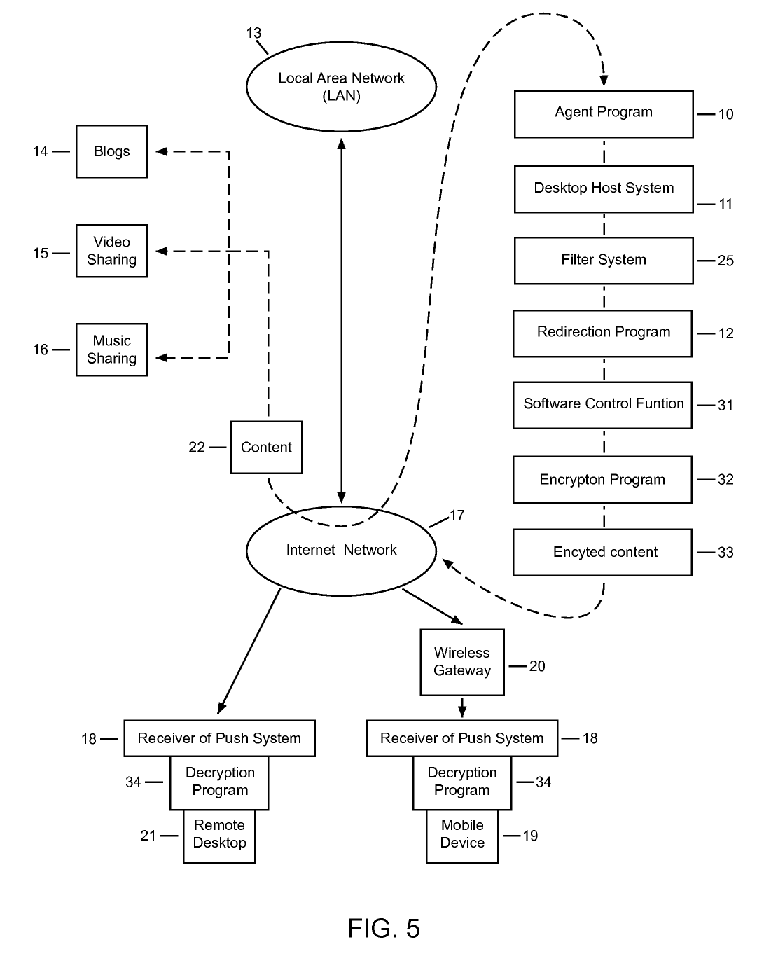

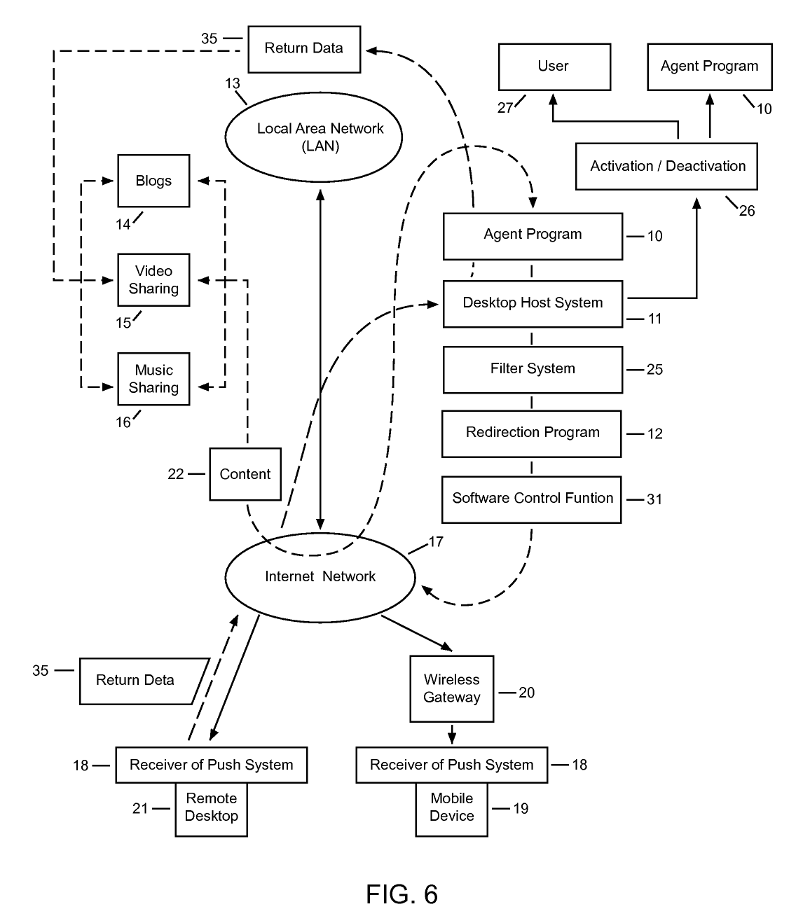

FIG. 4 is another alternate example of present invention where the system diagram of FIG. 2 is partially depicted which includes the agent program 10, the host system residing on the sever computer 23, the redirect program 12. Further depicted is a remote control device 28 that allows user to configure the push system where an user 27 can either access the remote control device via an intranet web page 29, an internet web page 30. In the alternative, the remote control device is installed on the remote device such as remote desktop 21 or mobile device 19 where an user 27 can access the remote control device 28 to configure the push system.

In FIG. 5, the system diagram of FIG. 3 is depicted with encryption program 32 encrypting the content 33 before it is redirected to the remote device 21 and or 19. In this depiction, the remote device 21 or 19 is installed with a decryption program 34 where it is capable of decrypting the encrypted content 33.

In FIG. 6, the system diagram of FIG. 3 is depicted here which further includes the receiver 18 capable of sending returning data item 35, in response to receiving new content 22 from the redirect program 12, back to the host system 11, wherein the agent program 10, after detecting the returning data item 35 being received by the host system 11, will redirect the returning data item 35 to a location based on at least one predetermined attribute. In this depiction, the returning date item 35 is routed back to the original website including the blog site 14, the video sharing site 15, and the music sharing site 16.

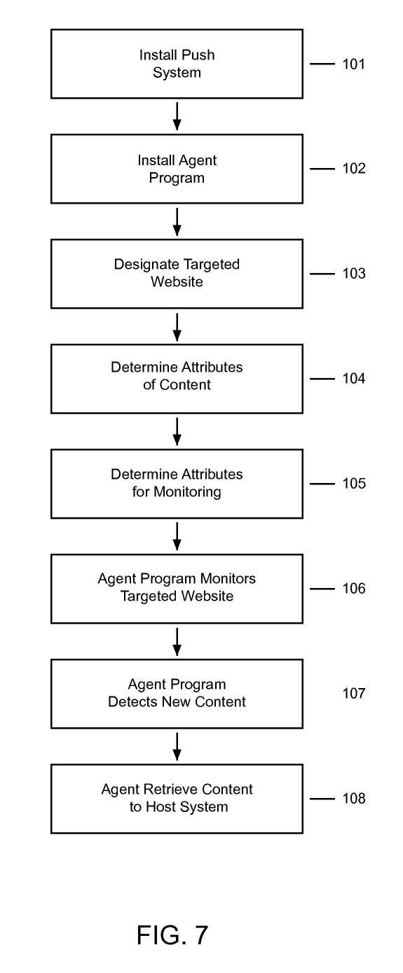

Turning to FIG. 7, this figure is a flow chart showing the steps carried out by the agent program operating at the host system and how it interfaces with the designated websites Specifically, the user installs the push system which includes the host system at a computer, preferably a desktop computer or a network server 101. The push system installs the agent program 10 of the push system at the host system 102. The user then designates the targeted website to be monitored 103.

Then the user determines the attributes of the content to be monitored 104. For example, the user may choose to monitor new video files that are related to surfing in Thailand. For this example, the user is able to input attributes such as “video file” with keyword of the title containing “surf” and “Thailand.” For another example, the user may choose to monitor new blogs that are related to political debates concerning global warming. In this context, the user will be able to input attributes like text listings with keyword of the text or of the title of the text containing “global warming,” and “political debates.” These examples are not intended to limit the breadth and scope of the invention, but rather to illustrate the variety of possibilities embodied in the redirection concept.

Next the agent program of the push system monitors the target designated websites for new content based on the predetermined attributes 106. When there are new contents available on the targeted website, the agent program is able to detect the new content and retrieve the content to the host system 108.

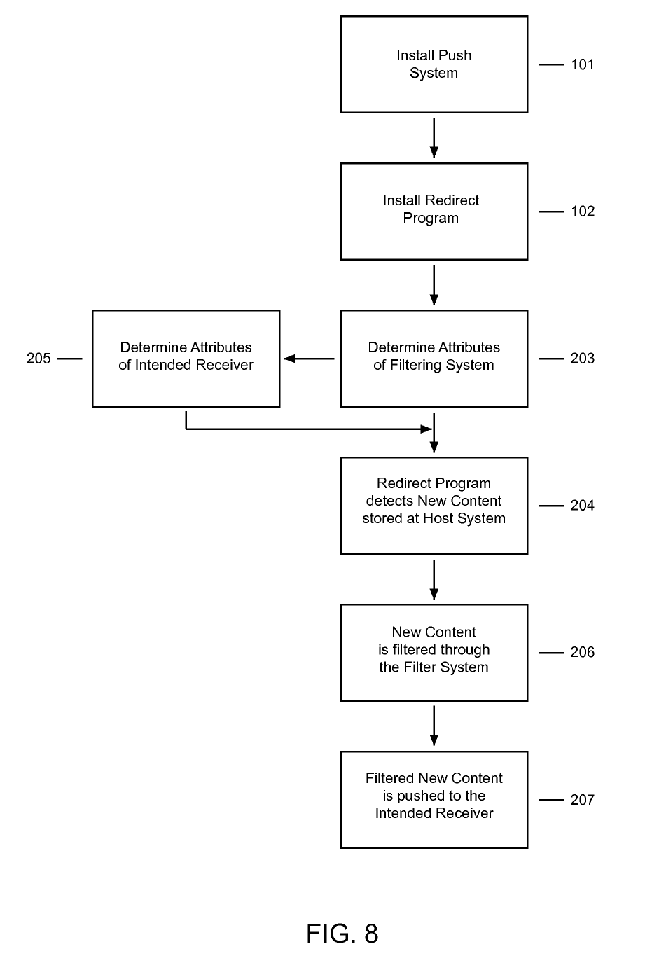

In FIG. 8, the figure is a flow chart showing the steps carried out by the redirect program operating at the host system and how it redirects the content to the remote device installed with the receiver of the push system. After the user installs the push system 101, the push system installs the redirect program 102. The redirect program contains a filtering system. Then the user determines the attributes for the filtering system 203. Particularly, the user inputs attributes to filter out the content that contains those attributes. For example, the user determines that any video file exceeding 5 megabyte should not be forwarded to the remote device. In this context, the filtering system will not redirect the video file if the size of the video file exceeds 5 mb. This example is not intended to limit the breadth and scope of the invention, but rather to illustrate the variety of possibilities embodied in the redirection concept.

Optionally, the user may also determine the attributes for the intended receiver as it is installed on the remote device 205. In this stage, the user may determine the orders to which the content is redirected to the intended receivers. For example, an user can provide inputs as to determine that any video file containing keyword “surf” and “Thailand” will be redirected to the mobile device installed for the receiver and then two hours later the same content be redirected to the remote desktop installed with the receiver. In another example, the user can determine that new text content are to be forwarded to the mobile device installed with the receiver, new video file content are to be forwarded to the remote desktop. In yet another example, where the content may contain a video clip, an audio clip and a txt file, the user can predetermine that the audio clip be delivered to the user's remote laptop, the video clip be delivered to the cell phone and the txt file be delivered to the remote desktop. These examples are not intended to limit the breadth and scope of the invention, but rather to illustrate the variety of possibilities embodied in the redirection concept.

Next, the redirect program detects new content at the host system 204 and using the filer system, determines whether the content needs to be redirected 206. Once the redirect program determines the content is to be redirected, it redirects the content to the intended receiver based on the predetermined attributes 207.

What is claimed is:

1. A push system for redirecting data item from a website to a remote device comprising:
a host system residing in a computer,
at least one agent program that is capable of recognizing new content on at least one designated website,
wherein said agent program is capable of retrieving said new content from said designated website to said host system,
at least one redirect program wherein said redirect program redirects said new content from said host system to at least one receiver installed in at least one remote system.

2. The push system of claim 1 wherein said host system further comprising at least one filtering system to filter said new content before said new content is redirected to said receiver.

3. The push system of claim 2 wherein said filter system having at least one filtering rule based on at least one predetermined attribute.

4. The push system of claim 3 wherein said predetermined attribute is provided by an user.

5. The push system of claim 1 wherein said push system supports at least one user.

6. The push system of claim 1 further comprising a configurable activation/deactivation switch capable of activating/deactivating a particular user.

7. The push system of claim 1 further comprising a configurable activation/deactivation switch capable of activating/deactivating said agent program for a particular user.

8. The push system of claim 1 wherein said new content is determined based on at least one predetermined attribute.

9. The push system of claim 5 wherein said predetermined attribute is provided by a user.

10. The push system of claim 1 wherein the computer is a sever computer.

11. The push system of claim 1 wherein the new content is text, video, or music.

12. The push system of claim 1 wherein said agent program is scheduled to detect said new content continuously.

13. The push system of claim 1 wherein said agent program is scheduled to detect said new content intermittently based on at least one predetermined attribute.

14. The push system of claim 1 wherein said host system further comprising:
a software-implemented control function for determining a preferred list of content types that are to be redirected.

15. The push system of claim 1 wherein said host system further comprising:
a software-implemented control function for determining whether said remote device can receive or process said new content.

16. The push system of claim 1 wherein said host system further comprising:
a remote device control function wherein said remote device control function allows said user to configure said host system from a remote device.

17. The push system of claim 16 wherein said remote device control function further comprising an internet or an intranet web component, wherein an user can configure said host system by accessing said remote device control function via a web page.

18. The push system of claim 1 wherein said redirect program pushes said new content to said receiver via local-area-network.

19. The push system of claim 1 wherein said redirect program pushes said new content to said receiver via wide-area-network.

20. The push system of claim 1 further comprising:
an encryption program residing in said host system wherein said encryption program encrypts said new content to form an encrypted new content;
a decryption program residing in said remote device wherein said decryption program decrypts said encrypted new content.

21. The push system of claim 1 wherein said receiver is capable of sending at least one returning data item back to said host system, wherein said agent program will redirect the returning data item to a location according to at least one predetermined attribute.

22. A method of gathering new content from a designated website and redirect said new content to a remote device comprising the steps of:
determining a designated website to be monitored;
determining a type of new content to be detected at the designated website;
monitoring said new content at said designated website by an agent program;
detecting new content at the designated website by said agent program;
retrieving said new content from the designated website to a host system by said agent program;
providing a set of filtering rules;
filtering said new content using said filtering rules by a redirect program;
redirecting said new content to a receiver installed at a user's remote device by the redirect program.

23. The method of claim 22 wherein an user can configure the steps of claim 22.

24. The method of claim 22 wherein an user can remotely configure the steps of claim 22.

25. The method of claim 22 further comprising the steps of:
encrypting said new content by an encryption program prior to redirecting said new content to a user's remote device;
decrypting said new content by a decryption program after said new content has been redirected to a user's remote device.

26. The method of claim 22 further comprising the steps of:
sending at least one returning data item back to said host system by said receiver;
redirecting said returning data item to a location according to at least one predetermined attribute by said agent.
